(19) United States
(12) Patent Application Publication
(10) Pub. No.: US 2024/0141719 A1
(43) Pub. Date: May 2, 2024

(54) FENESTRATION ASSEMBLY WITH OPERABLE FLOATING SASH AND METHODS FOR SAME

(71) Applicant: Marvin Lumber and Cedar Company, LLC d/b/a Marvin Windows and Doors, Eagan, MN (US)

(72) Inventor: David M. Lund, Detroit Lakes, MN (US)

(21) Appl. No.: 18/499,850

(22) Filed: Nov. 1, 2023

Related U.S. Application Data
(60) Provisional application No. 63/421,431, filed on Nov. 1, 2022.

(51) Int. Cl. E06B 7/18

(52) U.S. Cl. CPC E06B 7/18; E06B 3/44

(57) ABSTRACT

A fenestration assembly includes a fenestration frame and at least one floating sash movably coupled within the fenestration frame. The at least one floating sash is configured to move between open and closed positions within the fenestration frame. The floating sash includes a sash perimeter extending around the floating sash and a sash face. A floating seal is coupled along the sash face. The floating seal includes compressed and relaxed configurations. In the relaxed configuration the floating seal is relaxed and the floating sash is movable between the open and closed positions. In the compressed configuration the floating seal is compressed relative to the relaxed floating seal in the relaxed configuration.

### CLAIM OF PRIORITY

This patent application claims the benefit of priority of Lund, U.S. Provisional Patent Application Ser. No. 63/421,431, entitled “FENESTRATION ASSEMBLY WITH OPERABLE FLOATING SASH AND METHODS FOR SAME,” filed on Nov. 1, 2022 (Attorney Docket No. 1261.198PRV), which is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Marvin Lumber and Cedar Company, LLC d/b/a Marvin Windows and Doors, of Eagan, Minnesota, USA. All Rights Reserved.

### TECHNICAL FIELD

This document pertains generally, but not by way of limitation, to fenestration assemblies having operable sashes.

### BACKGROUND

Fenestration assemblies, including window and door assemblies, include movable panels such as sashes. In one example, window assemblies include single or double hung assemblies having one or two movable sashes. The sashes are movable within the fenestration frame between open and closed positions. The sashes include weather stripping along respective sash perimeters that slide over the proximate portions of the fenestration frame with opening and closing of the sashes. The weather stripping decreases the ingress of moisture, drafts, pests, dusts or the like and similar minimizes the loss of heat during the winter and ingress of heat during the summer.

### SUMMARY

The present inventors have recognized, among other things, that a problem to be solved can include easing sliding movement of sashes within fenestration frames while at the same time maintaining or enhancing the benefits of seals interposed between movable sashes and the fenestration frame. In some examples, single hung or double hung fenestration assemblies include one or plural sashes that are slidable within fenestration frames (e.g., in contrast to casement windows having sashes that rotate at least partially outside of fenestration frames). The sashes include weather stripping along sash perimeters, and the weather stripping is compressed in an ongoing consistent manner between the sash perimeter and the fenestration frame to ensure sealing therebetween and minimize the ingress of pests, drafts or the like while minimizing the loss of heat (in winter) or ingress of heat (during the summer).

The compression of the weather stripping generates friction between the sashes and the fenestration frame that resists sash movement. Occupants apply force, sometimes significant force, to the sash to overcome friction forces and initiate movement of the sashes. In some examples, balance tubes having springs, pulleys or the like assist with this movement. However, initial movement of the sashes may still include significant input force from an occupant to initiate movement. In some examples, the initial movement precipitates undesired slamming and crashing of the sashes as the occupant applies force to begin the initial movement and the sash ‘flies’ up or down toward an opposed end of the fenestration frame.

Additionally, the ongoing compression of the weather stripping in examples may facilitate beneficial properties of weather stripping (e.g., sealing, insulation or the like) however the ongoing compression and friction along the weather stripping also accelerate wear of the weather stripping with sliding movement of the sashes. For instance, as sashes move within fenestration frames the weather stripping is slid over corresponding portions of the frame repeatedly. The ongoing compression of the weather stripping enhances normal forces incident on the weather stripping and the associated friction forces, and accordingly accelerates wear.

The present examples of fenestration assemblies provide solutions to these problems. The fenestration assemblies described herein include one or more floating sashes configured to readily move between open and closed positions, for instance in the manner of single or double hung windows (e.g., within the fenestration frame). The described fenestration assemblies include floating seals that transition between compressed and relaxed configurations. When movement of the floating sash is specified the compression of the floating seal is relaxed (though not necessarily uncompressed or neutral although it may be permissible). The floating seal remains coupled between the floating sash and the fenestration frame to minimize the ingress of pests, drafts or the like while maintaining the insulation properties of the floating seal. The relaxation of compression decreases the normal force incident on one or more of the sash frame, fenestration frame and floating seal and correspondingly decreases friction forces. Accordingly, movement of the floating sash between open and closed positions is eased for the occupant. By relaxing compression of the floating seal movement of the floating sash is eased, and additionally wear of the floating seal is decreased.

When securing of the floating sash is specified (e.g., for closing, securing in a specified open position or the like) the floating seal is compressed, and friction forces increase thereby increasing the force required to move the floating sash. In an example including closing of the floating sash the floating seal is compressed to enhance insulation properties and further minimize the ingress of pests, drafts or the like. Optionally, because the floating seal is toggled between compressed and relaxed configurations to ease movement, compression when movement is not desired may be enhanced in comparison to weather stripping to enhance insulation properties, resistance to pest, moisture and draft ingress or the like.

In one example, the floating seal is provided along a sash face of the floating sash in contrast to a sash perimeter (e.g., in the manner of weather stripping). The sash face is opposed to a corresponding feature of the fenestration frame, such as an opposed frame, jamb stop or the like. The floating sash is configured for movement in a different direction than opening and closing movement to facilitate compressing and relaxing of the floating seal. For instance, the floating sash is translated between first and second lateral positions within the fenestration frame (e.g., toward and away from the fenestration exterior and interior). In the first lateral position the floating sash is recessed from an opposed portion of the fenestration frame and the intervening floating seal is relaxed (and movement of the sash is eased). In the second lateral position the floating sash is moved proximate to the opposed portion of the fenestration and the floating seal is accordingly compressed (and movement of the sash is impaired, and optionally arrested).

As described herein one or more cams are provided in various examples to facilitate transition between the relaxed and compressed configurations of the floating seal. In one example a seal hardware cam is provided with operation hardware of the fenestration assembly. The operation hardware secures the floating sash, and in this example also actuates a camming surface that is configured to bias the floating sash between the lateral positions that correspondingly relax and compress the floating seal.

In another example, a seal frame cam is provided between the floating sash and the fenestration frame. The seal frame cam includes a cam surface and a follower surface. In one example, the cam surface is coupled with the fenestration frame and the follower surface is coupled with the floating sash. Optionally, the cam surfaces have cooperating tapered profiles. As the floating sash is closed the cam surface engages with the follower surface and the floating sash is biased from the first lateral position toward the second lateral position to thereby compress the floating seal. In another example, the seal frame cam and the seal hardware cam work cooperatively to compress and relax the floating seal along the floating sash (e.g., proximate to the rails and stiles associated with the seal frame cam and the seal hardware cam).

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a perspective view of one example of a fenestration assembly including one or more floating sashes.

FIG. 2A is a vertical cross section of the fenestration assembly of FIG. 1.

FIG. 2B is a horizontal cross section of the fenestration assembly of FIG. 1.

FIG. 3 is a detailed vertical cross section of the fenestration assembly of FIG. 1 with an example floating seal in a relaxed configuration.

FIG. 4 is a detailed vertical cross section of the fenestration assembly of FIG. 1 with the example floating seal in a compressed configuration.

FIG. 5A is a first detailed horizontal cross section of the fenestration assembly of FIG. 1.

FIG. 5B is a second detailed horizontal cross section of the fenestration assembly of FIG. 1.

FIG. 6 is a perspective view of one example of operation hardware including a seal hardware cam.

FIG. 7 is a perspective view of one example of a keeper configured for use with the operation hardware of FIG. 6.

FIG. 8A is a perspective view of the operation hardware of FIG. 6 in a secure configuration configured to compress a floating seal.

FIG. 8B is a perspective view of the operation hardware of FIG. 6 in an unsecure configuration configured to relax compression of a floating seal.

FIG. 9 is a perspective view of the operation hardware of FIG. 5 in a tilting configuration.

FIG. 10A is a perspective view of another example of operation hardware in an unsecure configuration.

FIG. 10B is a perspective view of the operation hardware of FIG. 10A in a tilting configuration.

FIG. 11A is a perspective view of one example of a float linkage in a first orientation.

FIG. 11B is a perspective view of the float linkage of FIG. 11A in a second orientation.

FIG. 12A is a detailed horizontal cross section of the fenestration assembly of FIG. 1 with a jamb stop assembly transitioning to a retracted configuration.

FIG. 12B is a detailed horizontal cross section of the fenestration assembly of FIG. 1 with the jamb stop assembly in the retracted configuration.

### DETAILED DESCRIPTION

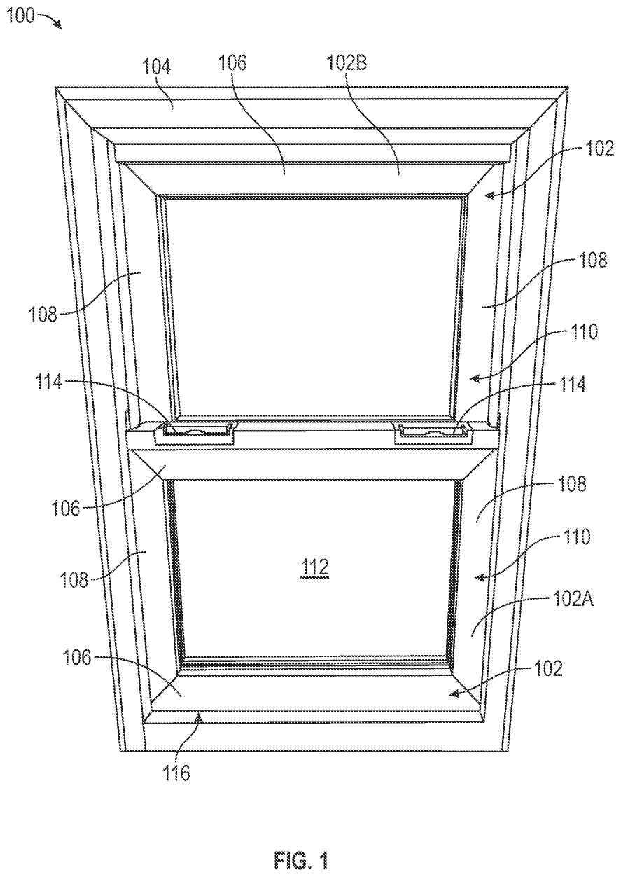

FIG. 1 is a perspective view of one example of a fenestration assembly 100 including one or more floating sashes 102. For instance, the fenestration assembly 100 includes a first floating sash 102A and a second floating sash 102B (collectively, sashes 102). The floating sashes 102 are moveable relative to a fenestration frame 104. For example, the floating sashes 102 slide (e.g., upward and downward) within the fenestration frame 104 to open and close the fenestration assembly 100. Accordingly, the floating sashes 102 move between an open position and a closed position. In another example, the floating sashes 102 are configured to move in a direction transverse, such as at angle, laterally or the like, relative to the opening and closing movement. As discussed herein, the movement of the floating sashes 102, for instance transversely, facilitates compressing and relaxing of a floating seal. As described in greater detail herein, the floating sashes 102 are translated between first and second lateral positions within the fenestration frame 104 (e.g., normal to the sash face, toward and away from the fenestration exterior and interior, or the like). The fenestration assembly 100 shown in FIG. 1 includes a window assembly. In other examples, the fenestration assemblies described herein include door assemblies with the fenestration frame corresponding to a door frame, and the one or more sashes corresponding to sliding doors.

The floating sashes 102 include one or more sash rails 106 and one or more sash stiles 108. The sash stiles 108 extend between the sash rails 106, and the sash rails 106 extend between the sash stiles 108. The floating sashes 102 include a sash face 110 (and conversely include an opposed sash face directed toward the exterior). The sash face 110 includes the sash rails 106 and the sash stiles 108. The floating sashes 102 include a glazing unit 112 (e.g., glass pane, pane assembly, or the like). For instance, the sash rails 106 and the sash stiles 108 surround and seat the glazing unit 112.

FIG. 1 shows the fenestration assembly 100 includes operation hardware 114. In an example, the operation hardware 114 facilitates securing of the fenestration assembly 100. In another example, the operation hardware 114 facilitates tilting operation of the floating sashes within the fenestration frame 104, for instance, to facilitate cleaning of the glazing unit 112 including the exterior surface of the glazing unit 112. As further described herein, the operation hardware 114 moves the floating sashes 102 in a transverse manner to selectively compress and relax one or more floating seals.

The fenestration assembly 100 has a perimeter reveal 116 between the fenestration frame 104 and the floating sashes 102. For example, the perimeter reveal 116 is a gap between the perimeter of the floating sashes 102 and the fenestration frame 104. The perimeter reveal 116 is, in one example, located between the fenestration frame 104 and one or more of the sash stiles 108 and sash rails 106. As discussed herein, the perimeter reveal 116 permits movement of the sashes 102 transverse to the opening and closing movement, and accordingly toward and away from opposed portions of the fenestration frame 104 (e.g., enlarging and shrinking the reveal 116). The transverse movement correspondingly compresses and relaxes one or more floating seals. Compression of the floating seals provides a robust seal between the sashes 102 and fenestration frame 104. Conversely, relaxing of the floating seals permits easy opening and closing movement of the sashes 102

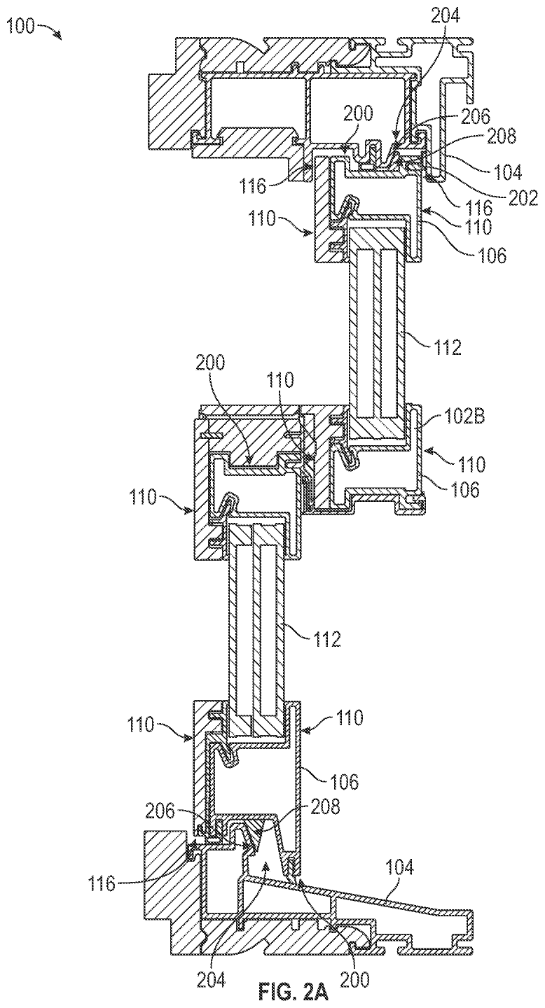

FIG. 2A is a vertical cross section of the fenestration assembly 100 of FIG. 1. The fenestration assembly 100 includes the floating sashes 102 coupled with the fenestration frame 104. Each of the floating sashes 102 includes sash rails 106 (and sash stiles 108 shown in FIG. 2B) surrounding the glazing unit 112. The floating sashes 102 have a sash perimeter 200. For example, the sash perimeter 200 corresponds with an outer edge of the sash rails 106 and the sash stiles 108. Accordingly, the sash perimeter 200 extends around the floating sashes 102.

In an example, the fenestration assembly 100 has the perimeter reveal 116 between the fenestration frame 104 and the floating sashes 102. The perimeter reveal 116 is, in one example, located between the fenestration frame 104 and one or more of the sash stiles 108 and sash rails 106. The perimeter reveal 116 permits movement of the sashes 102 transverse to the opening and closing movement, and accordingly toward and away from opposed portions of the fenestration frame 104 (e.g., enlarging and shrinking the reveal 116). The transverse movement correspondingly compresses and relaxes one or more floating seals, including the floating seal 202.

FIG. 2A shows a first example of a floating seal 202 of the fenestration assembly 100. The floating seal 202 is coupled between the floating sash 102 (the upper sash 102A in this example) and the fenestration frame 104 to minimize the ingress of pests, drafts or the like. For instance, the floating seal 202 is coupled along the sash face 110 of the floating sashes 102. As further shown in FIG. 2A, the floating seal 202 is positioned within the perimeter reveal 116. The floating seal 202 extends toward the fenestration frame 104 from the floating sashes 102, for instance to minimize the ingress of pests, drafts, or the like through the gap between the floating sashes 102 and the fenestration frame 104 (e.g., through the perimeter reveal 116, or the like). In another example, the floating seal 202 is coupled with the fenestration frame 104 and extends toward the floating sash 102. Accordingly, in either example, the floating seal 202 is coupled between the sash face 110 and the fenestration frame 104. As described herein, the floating seal 202 is selectively compressed and relaxed with lateral movement of the floating sash 102 to selectively provide robust sealing and ease of opening and closing movement.

As discussed above, the floating seal 202 has a relaxed configuration and a compressed configuration. In the relaxed configuration, the floating seal 202 is relaxed. For instance, the perimeter reveal 116 is expanded and the floating seal 202 is permitted to relax and expand. In one example, the floating seal 202 is coupled with the fenestration frame 104 in the relaxed configuration. In the compressed configuration, the floating seal 202 is compressed relative to the floating seal 202 in the relaxed configuration. For example, the perimeter reveal 116 is compressed with lateral movement of the sash 102, and the floating seal 202 is compressed between the sash 102 and the fenestration frame 104. In another example, in the compressed configuration, the floating seal 202 is engaged with the fenestration frame 104.

As discussed herein, the floating sashes 102 are configured to laterally move relative to movement of the floating sashes 102 between open and closed positions. In an example, the floating sashes move laterally (e.g., left or right in FIG. 2A) in comparison to opening and closing of the sashes (e.g., up or down in FIG. 2A). In another example, the lateral movement of the floating sashes 102 transitions the floating seal 202 between the relaxed configuration and the compressed configuration. For instance, and referring to FIG. 2A, the floating sashes 102A moves laterally toward the left to relax the floating seal 202 and to the right to compress the floating seal 202. In a first example, the floating sash 102A is in a first lateral position (e.g., biased to the right relative to the left perimeter seal 202) and the floating seal 202 is in the compressed configuration within the right perimeter reveal 116, as shown in FIG. 2A. In a second example, the floating sash 102A is in a second lateral position (e.g., biased to the left relative to left perimeter reveal 116) and the floating seal 202 is in the relaxed configuration within the right perimeter reveal 116.

In an example, the one or more cams are provided with the fenestration assembly 100 to facilitate transition between the relaxed and compressed configurations of the floating seal 202. In one example a seal hardware cam is provided with operation hardware 114 of the fenestration assembly 100. As described in greater detail herein, the operation hardware 114 actuates a camming surface configured to bias the floating sash 102 between the lateral positions that relax and compress the floating seals. Optionally, the operation hardware secures the floating sash 102 to the fenestration frame 104 (e.g., locks and unlocks the floating sash 102).

In another example, shown in FIG. 2A, a seal frame cam 204 is provided between the floating sash 102A (or floating sash 102B) and the fenestration frame 104. For instance, the seal frame cam 204 is included with one or both of the floating sash 102 or the fenestration frame 104. The seal frame cam 204 includes a cam surface 206 and a follower surface 208. In one example, the cam surface 206 is coupled with the fenestration frame 104 and the follower surface 208 is coupled with the floating sash 102. Optionally, the cam and follower surfaces 206, 208 have cooperating tapered profiles. As the floating sash 102A is closed the cam surface 206 engages with the follower surface 208 and the floating sash 102A is biased from the first lateral position toward the second lateral position (to the right and shown in FIG. 2A). Bias of the floating sash 102A compresses the floating seal 202 and provides an enhanced seal between the sash 102A and the fenestration frame 104.

The follower surface 208 moves along the cam surface 206 (e.g., slidably) to displace the sashes 102 toward the second lateral position. In another example, the seal frame cam 204 and the seal hardware cam (described herein) work cooperatively to compress and relax one or more floating seals (including floating seal 202) between the floating sashes 102 (e.g., proximate to the rails 106 and stiles 108 associated with the seal frame cam 204 and the seal hardware cam) and the fenestration frame 104.

FIG. 2B is a horizontal cross section of the fenestration assembly of FIG. 1. FIG. 2B shows the glazing unit 112 (partially) surrounded by the sash stiles 108. Additionally, the floating seal 202 is shown coupled between the sash face 110 (stiles) and the fenestration frame 104. For instance, the floating seal 202 is shown in the compressed configuration in FIG. 2B. In FIG. 2B as the floating sash 102A is closed the cam surface 206 engages with the follower surface 208 (shown in FIG. 2A) and the floating sash 102A is biased from the first lateral position toward the second lateral position (to the right as shown in FIG. 2B). Accordingly, the floating seals 202 are compressed between the frame 104 and the sashes 102.

In an example, the fenestration assembly 100 has the perimeter reveal 116 between the fenestration frame 104 and the floating sashes 102. The perimeter reveal 116 is, in one example, located between the fenestration frame 104 and one or more of the sash stiles 108 (shown in FIG. 2B) and sash rails 106 (shown in FIG. 2A). The perimeter reveal 116 permits movement of the sashes 102 transverse to the opening and closing movement, and accordingly toward and away from opposed portions of the fenestration frame 104 (e.g., enlarging and shrinking the reveal 116). The transverse movement correspondingly compresses and relaxes one or more floating seals, including the floating seal 202, within the perimeter reveal 116. As further described herein, in another example the operation hardware 114 biases one or both of the floating sashes 102 transverse to opening and closing sash movement, and thereby compresses and relaxes the one or more floating seals 202. In another example, the fenestration assemblies described herein include one or both of the operation hardware 114, seal frame cams 204 or the like compress and relax the floating seals 202. Optionally, where both the hardware 114 and the seal frame cams 204 are included these features work cooperatively to bias the floating seals 202.

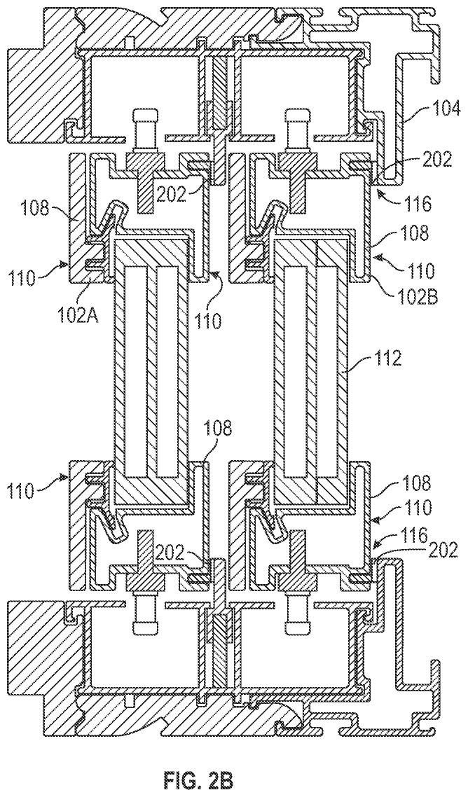

FIG. 3 is a detailed vertical cross section of the fenestration assembly of FIG. 1 with the floating seal 202 of FIG. 2A in a relaxed configuration. FIG. 3 shows the first floating sash 102A and the second floating sash 102B in partially open positions with the sashes 102A, B laterally moved relative to FIG. 2A. Additionally, the first and second floating sashes 102A, B are transitioning toward the closed position. For instance, the first floating sash 102A is moved upward and the second floating sash 102B is moved downward.

As previously described, the seal frame cam 204 is provided between the floating sash 102A and the fenestration frame 104. The seal frame cam 204 includes the cam surface 206 and the follower surface 208. As shown in FIG. 3, because the sashes 102A, B are not closed (or transitioning from open toward closed) the cam surface 206 is initially disengaged with the follower surface 208, and the floating seal 202 is accordingly relaxed. With continued movement of the one or both of the sashes 102A, B toward closed positions the cam surface 206 engages with the follower surface 208 and the cam and follower laterally move the floating sash 102A toward the right thereby compressing the floating seal 202 in FIG. 3. For instance, the cam surface 206 and the follower surface 208 have complementary tapers to impart a bias when cooperatively coupled with each other. The decoupling of the cam surface 206 from the follower surface 208 (e.g., with opening movement) decreases the bias supplied by the seal frame cam 204, permits the floating sash 102 to move left (relative to the page) and the floating seal 202 relaxes.

FIG. 3 shows the first floating sash 102A and the second floating sash 102B in a first lateral position. In the first lateral position the floating sash is recessed from an opposed portion of the fenestration frame 104 and the intervening floating seal 202 is relaxed (and movement of the sash is eased). In another example, the floating seal 202 is in the relaxed configuration in correspondence with the floating sashes 102A, 102B in the first lateral position. Accordingly, the floating sashes 102A, 102B are moveable with less force between the open and closed positions. Thus, movement of the floating sash 102A, 102B is eased in correspondence with relaxing of the floating seal 202 to the relaxed configuration. For example, forces to move the sashes 102A, 102B between open and closed positions are less in comparison to a fenestration assembly 100 with a weather strip or similar that is consistently compressed between the sashes 102A, 102B and the fenestration frame 104. Relaxation of the floating seals 202 is conducted around the sashes 102A, 102B with movement of the seal frame cam 204 (and optionally the fenestration hardware 114) and decreasing of bias through the fenestration assembly 100 to permit easy movement of the sashes 102A, 102B. The relaxation of compression decreases the normal force incident on one or more of the sashes 102A, B, fenestration frame 104 and floating seals 202 and correspondingly decreases friction forces therebetween. Accordingly, movement of the floating sash 102 between open and closed positions is eased for a user. Additionally, relaxation of compression of the floating seal also decreases wear of the floating seal 202 according to the decreased normal forces and friction.

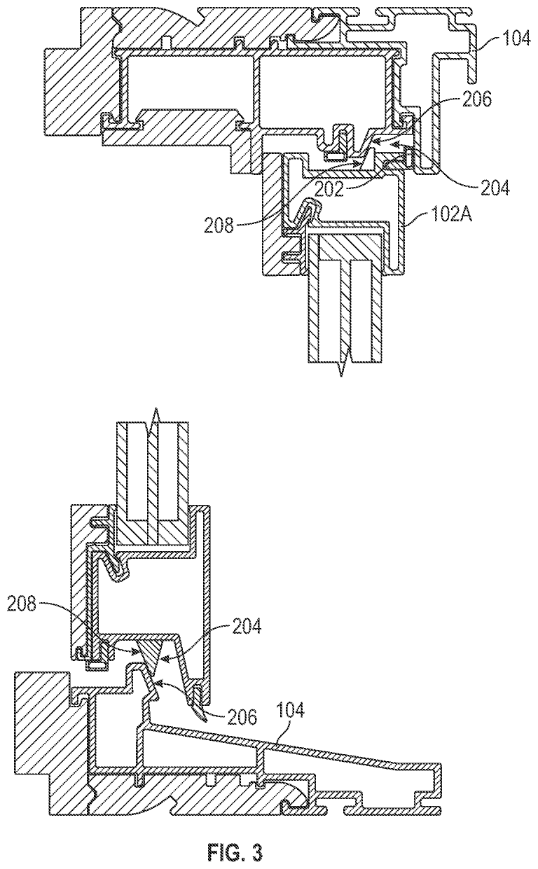

In contrast to FIG. 3, FIG. 4 is a detailed view of the sashes 102 of FIG. 2A in closed positions. FIG. 4 illustrates the first floating sash 102A and the second floating sash 102B in closed positions with the seal frame cams 204 biasing the sashes 102A, B and compressing the floating seal 202. Thus, floating seal 202 is in a compressed configuration in FIG. 4. In another example, the floating seal 202 associated with each of the first floating sash 102A and the second floating sash 102B is transitioned between the relaxed configuration and the compressed configuration according to the lateral movement of the floating sashes 102. For example, the floating sashes 102 are closed and shown in the second lateral position according to bias supplied by the seal frame cam 204. This view is also shown in FIG. 2A (zoomed out). In an example, the cam surface 206 imparts a bias to the follower surface 208 and the floating sash 102A (or floating sash 102B). The complementary tapers of the cam surface 206 and the follower surface 208 impart a bias when the cam surface is cooperatively coupled along the follower surface 208.

FIG. 4 shows the seal frame cam 204 associated with the first sash 102A. The biasing force generated by the seal frame cam 204 (through engagement of the cam surface 206 with the follower surface 208) associated with the first floating sash 102A is transmitted from the first floating sash 102A to the second floating sash 102B. For instance, the first floating sash 102A has the sash rail 106 adjacent the sash rail 106 of the second floating sash 102B. For instance, an interlock 400 between the first floating sash 102A and the second floating sash 102B transmits bias between the sashes 102 to compress floating seals associated with the sashes 102. In another example, the interlock 400 locks the first and second floating sashes 102 together (when closed) and accordingly prevents movement of either of the sashes 102 (e.g., for additional security, minimize ingress of pests, or the like). Accordingly, forces incident upon the first floating sash 102A are transferred to the second floating sash 102B. Thus, the biasing forces generated by the seal frame cam 204 associated with the first floating sash 102A are transferred to the second floating sash 102B. As a result, the seal frame cam 204 associated with the first floating sash 102A cooperates with the seal frame cam 204 associated with the second floating sash 102B to bias the sashes 102 toward the second lateral position and thereby compress the associated floating seals 202. FIG. 4 shows arrows indicating the bias generated by the seal frame cam 204 (and the operation hardware 114).

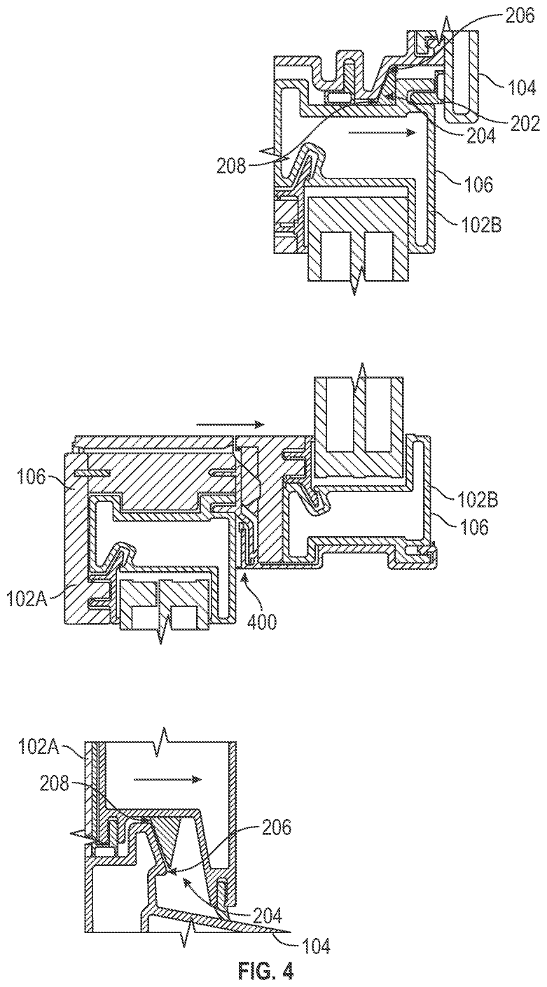

FIG. 5A is a first detailed horizontal cross section of the fenestration assembly 100 of FIG. 1. In an example, the fenestration assembly 100 has a deployable jamb stop 500 movable relative to the remainder of the fenestration frame 104. As described herein, the deployable jamb stop 500 is movable to permit tilting movement of one or more of the sashes 102A, B. Additionally, the deployable jamb stop 500 provides a sealing plain for engagement with the floating seal 202, for instance a floating seal 202 coupled along a face of the sash 102A as shown in FIG. 5A. The deployable jamb stop 500 (or the fenestration frame 104) permits compression of the floating seal 202 and provides affirmative sealing of as sash, such as first floating sash 102A with the fenestration frame 104.

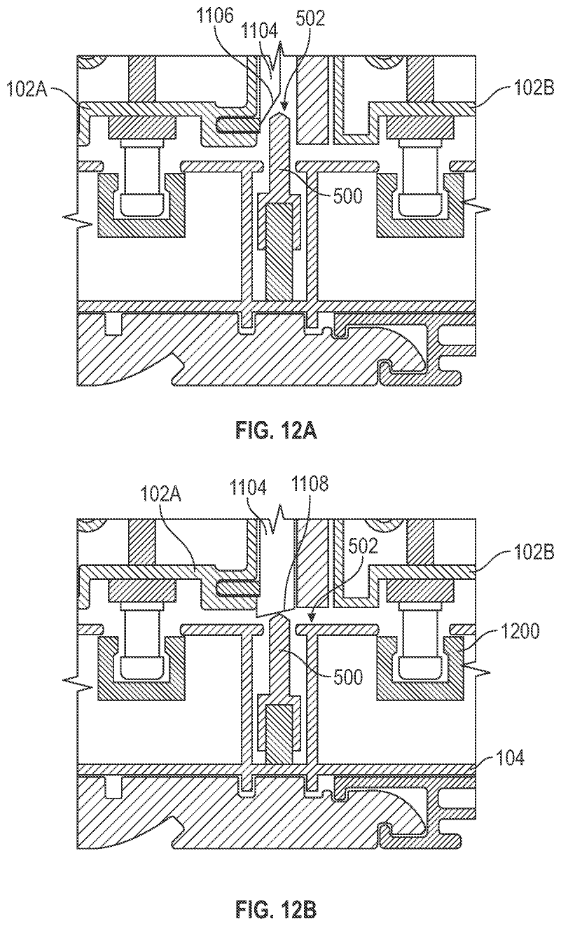

The deployable jamb stop 500 is configured to transition between a deployed configuration (shown in FIG. 5A) and a retracted configuration (shown in FIG. 12B). The deployable jamb stop 500 is included in a jamb stop assembly 502 having a jamb stop biasing element 504 that biases the jamb stop 500 toward the deployed configuration. The jamb stop biasing element 504 includes one or more of springs, elastic elements, or the like to supply the bias of the deployable jamb stop 500 toward the deployed configuration.

FIG. 5B is a second detailed horizontal cross section of the fenestration assembly 100 of FIG. 1. As described herein, the jamb stop assembly 502 includes the deployable jamb stop 500 and the jamb stop biasing element 504. The deployable jamb stop 500 is biased toward the deployed configuration in FIG. 5B. Accordingly, the deployable jamb stop 500 projects from the fenestration frame 104 and is interposed between the sashes 102A, B. Additionally, as shown in FIG. 5B the deployed jamb stop 500 provides a sealing plain for engagement with the floating seal 202 and compression of the floating seal 202. FIG. 5B shows the floating seal 202 in engagement with the deployable jamb stop 500 and the floating seal 202 in the compressed configuration. Thus, the deployable jamb stop 500 and the floating seal 202 cooperate to provide affirmative sealing of the first floating sash 102A.

In another example, and as described herein, the floating seal 202 is provided between the sash face 110 (in contrast to a perimeter edge of the sash) and an opposed portion of the fenestration frame 104. For example, see FIG. 5A, including the floating seal 202 of the sash 102B coupled between the sash and the fenestration frame 104. As previously described, and shown in FIG. 5A, a perimeter reveal 116 is provided between the sash 102B and the fenestration frame 104. Movement of the sash 102B laterally (e.g., transverse to opening closing movement) expands or contracts the reveal 116 correspondingly relaxing or compressing the floating seal 202.

In another example a perimeter reveal 506 is provided between a perimeter edge of the sash 102A and the fenestration frame 104. Because the floating seal 202 is provided between faces of the sashes 102A and the deployable jamb stop 500 and fenestration frame 104, instead of along an edge of the sash 102A (e.g., the sash perimeter 200, or the like) and associated portion of the frame 104, the perimeter reveal 506 is relatively small, and a tight interface is provided between the frame 104 and the sashes 102A, B. The tight interface provided by the perimeter reveal 506, in an example, minimizes the ingress of drafts, pests; enhances security of the fenestration assembly; improves aesthetics or the like. In other example fenestration assemblies (e.g., double and single hung windows) a weather strip is provided along the perimeter reveal 506 and is continually compressed between the frame 104 and the sash 102A. The continual compression enhances friction between the sash 102A and the frame 104 and accordingly frustrates opening and closing movement. Additionally, the perimeter reveal 506 in those example fenestration assemblies is enlarged to provide sufficient space for the weather strip.

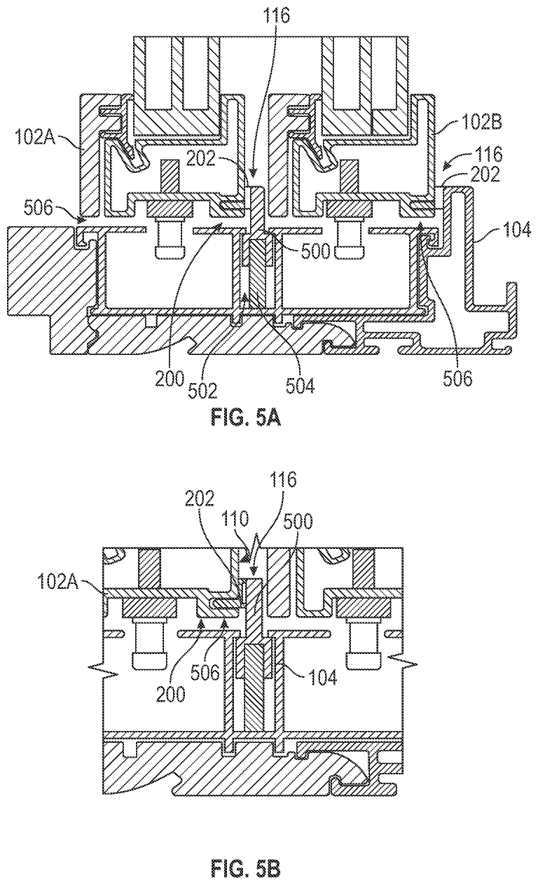

FIG. 6 is a perspective view of one example of operation hardware 114 including a seal hardware cam 600. The operation hardware 114 includes an operator 602 (e.g., a lever, knob, or the like) rotatably coupled with an operator housing 610 or an escutcheon 612 of the operator housing. The escutcheon 612 is a component of the operator housing 610. In another example, the escutcheon 612 is coupled with the operator housing 610. The operator 602 is coupled with the seal hardware cam 600. For example, the operator 602 actuates one or more of a latch bolt 604 or a cam member 606. In an example, the cam member 606 is a component of the seal hardware cam 600, and the cam member 606 interconnects the seal hardware cam 600 with the operator 602.

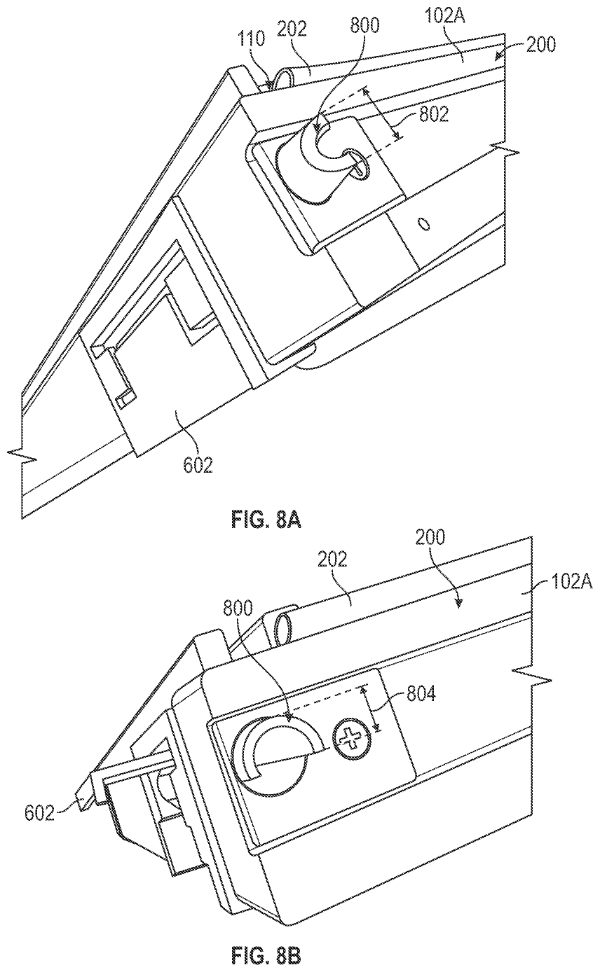

The seal hardware cam 600 is operatively coupled with the operator 602, for instance with a mechanism, such as a rack and pinion. Actuation of the operator 602 moves the seal hardware cam 600 (e.g., rotates the cam) and its associated camming surface along a proximate portion of the fenestration frame 104. Actuation of the cam 600 is shown in FIGS. 8A, B. The seal hardware cam 600 assists in transitioning the floating seals 202 (shown in FIG. 2A) between relaxed and compressed configurations. For instance, movement of the seal hardware cam 600 transversely moves the floating sash 102A (shown in FIG. 1) to correspondingly relax and compress the floating seals 202. In another example, the operation hardware 114 works cooperatively with the seal frame cams 204 described herein to relax and compress the floating seals 202. For instance, a camming bias provided by the seal frame cam 204 is applied to the sashes 102. Additionally, the seal hardware cam 600 provides a camming bias to the sashes 102 to bias the sashes 102 toward the second lateral position (shown in FIG. 4). The collective bias applied by the seal frame cam 204 and the seal hardware cam 600 laterally moves the sashes 102A, B (relative to opening and closing movement) and correspondingly compresses and relaxes the floating seals 202. In one example, the seal hardware cam 600 enhances compression and relaxing of floating seals 202 proximate to check rails and the stiles of the sashes 102A, B and the seal frame cams 204 enhance compression and relaxing of floating seals 202 along the stiles and bottom and top rails of the sashes 102A, B, respectively.

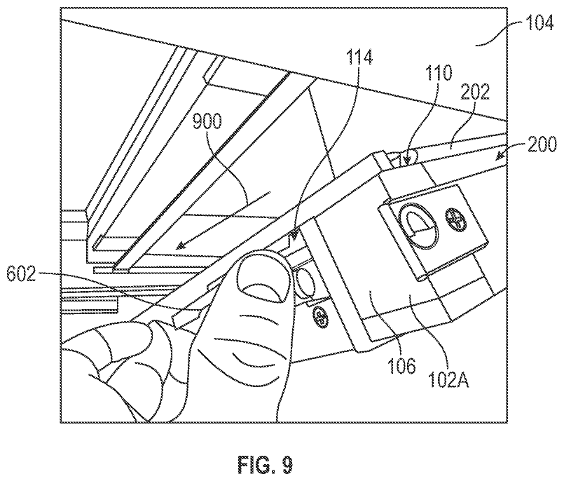

In another example, the operation hardware 114 includes a tilt slot 608. The tilt slot 608 permits lateral movement of the operator 602 within an operator housing 610. The tilt slot 608 facilitates retraction of the seal hardware cam 600 relative to the operator housing 610. Retraction of the seal hardware cam 600 disengages the cam 600 from the fenestration frame 104 to permit tilting movement of the sash. FIG. 9 shows the seal hardware cam 600 retracted thereby freeing the sash 102A to tilt. As shown in FIG. 6, the tilt slot 608 optionally extends to the left and right. The cam member 606 and the seal hardware cam 600 are similarly configured for installation to the right or left, and accordingly the operation hardware is ambidextrous and readily installed on right or left sides of a sash, for example the first floating sash 102A (shown in FIG. 1), or the like.

As described herein, a mechanism (e.g., rack and pinion, beveled gears, worm gears, or the like) interconnects the operator 602 with one or more of a latch bolt 604 or the cam member 606. In the example described above, the operator 602 is optionally translated into the tilt slot 608 (when rotated as shown in FIG. 8B) to retract the cam member 606. In another example, the mechanism includes worm gears. In this example, rotation of the operator 602 to the position shown in FIG. 8B drives the worm gears to retract the cam member 606 (e.g., without translation of the operator 602 into a tilt slot 608).

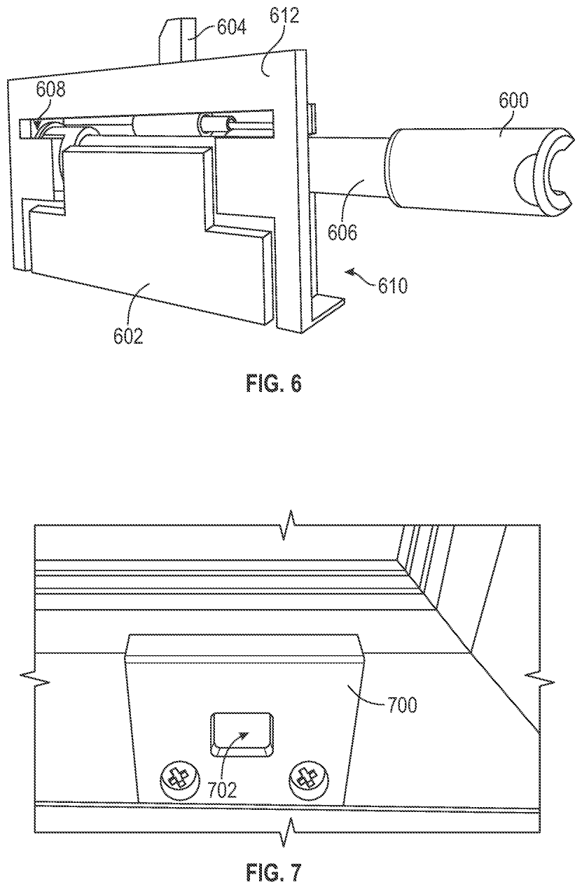

Referring to FIG. 6, and as described herein, the operation hardware 114 includes the latch bolt 604. The latch bolt 604 facilitates locking of the sashes 102 (shown in FIG. 1). For example, the operation hardware 114 is included in the first sash 102A (shown in FIG. 1), and the latch bolt 604 engages with a portion of the second sash 102B, such as a keeper 700 (see FIG. 7) to inhibit movement of the sashes 102 relative to the fenestration frame 104 (shown in FIG. 1). In an example, the latch bolt 604 is configured for reception in a bolt socket of a keeper (see 702 in FIG. 7). The latch bolt 604 within the bolt socket locks or secures the sashes 102. In another example, the operator 602 is operated (e.g., manipulated, rotated, flipped, or the like) to retract the latch bolt and unlock the sashes 102. Accordingly, the latch bolt 604 selectively inhibits movement of the sashes 102 relative to the frame 104.

The operator 602 and its associated mechanism consolidates, in one example, each of actuation of the latch bolt 604 and actuation of the cam member 606 (including rotation for application of bias and retraction for tilting). For instance, initial rotation of the operator 602 (to the configuration shown in FIG. 8B) retracts the latch bolt 604 to permit opening and closing movement of the sashes 102A, B. Additionally, initial movement rotates the cam member 606 to relax bias otherwise provided to the floating seals 202. In another example, rotation of the operator toward the position in FIG. 8A deploys the latch bolt 604 and rotates the cam member 606 to apply bias to one or more of the sashes 102A, B and thereby compress the floating seals 202. In still another example, further movement of the operator 602, such as translation into the tilt slot 608 or further rotation (e.g., with a worm gear mechanism) retracts the cam member 606 to permit tilting movement of the associated sash 102A, B.

FIG. 7 is a perspective view of one example of a keeper 700 configured for use with the operation hardware 114 of FIG. 6. For example, the keeper 700 has a bolt socket 702. The bolt socket 702 receives the latch bolt 604 (shown in FIG. 6), for instance to lock the sashes 102. In an example, the keeper 700 is associated with the second floating sash 102B (shown in FIG. 7. The operation hardware 114 (shown in FIG. 6) is associated with the first floating sash 102A. The latch bolt 604 is included in the operation hardware 114, and accordingly the latch bolt 604 is associated with the first floating sash 102A (shown in FIG. 1). The latch bolt 604 (shown in FIG. 6) projects into the bolt socket 702, for instance when the sashes 102 are in the fully closed position. Thus, the latch bolt 604 cooperates with the keeper 700 to lock the sashes 102.

FIG. 8A is a perspective view of the operation hardware of FIG. 6 in a secure configuration configured to compress a floating seal, for example the floating seal 202. FIG. 8A shows the floating seal 202 is provided along the sash face 110 (in contrast to being provided along the sash perimeter 200). Additionally, FIG. 8A shows the seal hardware cam 600 has a cam surface 800 that transitions from a compression orientation to a relaxed orientation (e.g., rotated relative to the compressed orientation, or the like). The cam surface 800 is in a position to bias the floating sash 102A away from a first portion of the fenestration frame and toward a portion of the frame opposed to the floating seal 202 and the sash face 110 (thereby compressing the floating seal 202 to the compressed configuration). Compression of the floating seal 202 increases the friction force between the floating sash 102A and the fenestration frame 104 (shown in FIG. 1), and accordingly assists in securing the floating sash 102A from moving while at the same time enhancing sealing between the floating sash 102A and the fenestration frame 104. For example, the floating seal 202 applies a first friction force to one or more of the fenestration frame 104 or the sash face 110 in correspondence with the floating seal in the relaxed configuration. In the compressed configuration, the floating seal 202 applies a second friction force to one or more of the fenestration frame 104 or the sash face 110. The second friction force is greater than the first friction force. Accordingly, friction is enhance with the floating seal 202 in the compressed configuration.

FIG. 8A shows the operator 602 in a first position (e.g., lowered, or the like) relative to the escutcheon 612. In contrast, FIG. 8B shows the operator 602 in a second position. For instance, the operator 602 is rotated relative to the position of the operator shown in FIG. 8A. Accordingly, the seal hardware cam 600 transitions the cam surface 800 between compression (shown in FIG. 8A) and relaxed (shown in FIG. 8B) orientations. For example, the cam surface 800 has a first lateral dimension 802 in the compression orientation (shown in FIG. 8A) that biases one or more of the sashes 102A, B and compresses the one or more floating seals 202. In another example, the cam surface 800 has a second lateral dimension 804 in the relaxed orientation (shown in FIG. 8B). The second lateral dimension 804 is narrower than the first lateral dimension 802, relaxes the bias on the one or more sashes 102A, B and correspondingly relaxes one or more of the floating seals 202. Accordingly, the cam surface 800 transitions between the relaxed orientation and the compression orientation.

FIG. 8B is a perspective view of the operation hardware 114 of FIG. 6 in an unsecure configuration configured to relax compression of a floating seal, for example the floating seal 202. The cam surface 800 is in a position to relax the bias (including disengagement or arresting of the bias) of the floating sash away from the first portion of the fenestration frame 104 (shown in FIG. 1) thereby relaxing compression of the floating seal 202 (to a relaxed configuration) between the frame 104 and sash 102A. Relaxation of the floating seal 202 decreases friction force between the floating sash 102A and the fenestration frame 104 and permits movement of the sash in opening and closing directions with less force than with other weather seals provided along the sash perimeter 200 that are consistently compressed.

FIG. 9 is a perspective view of the operation hardware 114 of FIG. 5 in a tilting configuration. For example, the operator 602 is moveable laterally, for instance along a check rail or sash rail 106 of the floating sash 102A. In an example, the operator 602 is moveable in the direction of arrow 900. Movement of the operator 602 is transmitted to the seal hardware cam 600 and laterally moves the seal hardware cam 600 to a retracted position (shown in FIG. 9) thereby permitting the floating sash 102A to tilt. FIG. 9 shows the sash 102A in a tilted configuration with the sash 102A tilted away from the fenestration frame 104. Accordingly, the seal hardware cam 600 is retractable into the floating sash 102A to permit tilting movement of the floating sash 102A.

In another example, FIG. 9 shows the sash face 110 and the sash perimeter 200. In yet another example, the seal hardware cam 600 projects from the sash perimeter 200 (e.g., when not retracted into the sash 102A). As further shown in FIG. 9, the floating seal 202 is coupled along the sash face 110. Accordingly, in this example, a seal is not coupled along the sash perimeter 200.

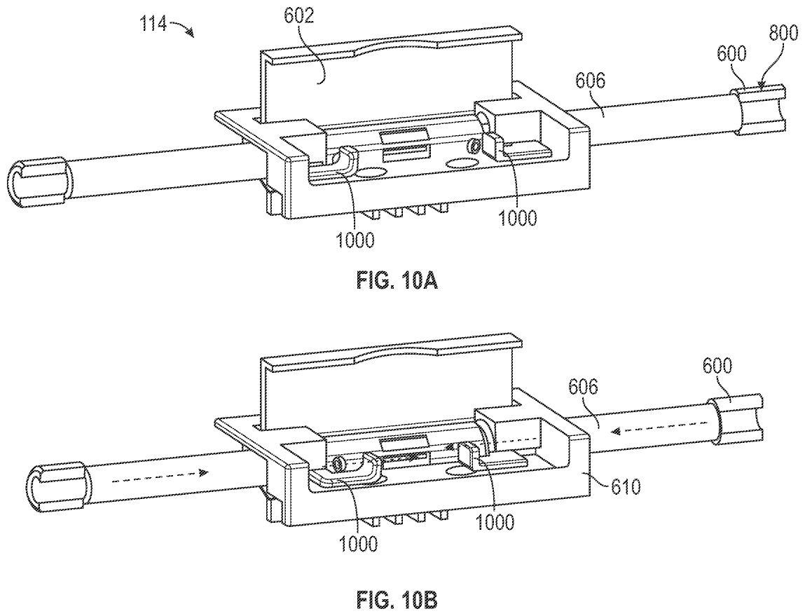

FIG. 10A is a perspective view of another example of operation hardware 114 in an unsecure configuration. The operator 602 is shown in a second position (e.g., rotated upward, or the like). Accordingly, one or more of the latch bolt 604 (shown in FIG. 4) or the cam member 606 are actuated (e.g., rotated, or the like). In this example, the cam surface 800 is a contoured surface that permits the floating sash 102A (shown in FIG. 1) to relax (and translate or move laterally) as shown in FIG. 10A when in this second (relaxed/passive) configuration. In another (rotated) compression configuration the rounded portion of the cam surface 800 is turned as shown in FIG. 8A to bias the floating sash 102A and accordingly compress the floating seals 202 (shown in FIG. 8A) as discussed herein.

In another example, and as described herein, the seal hardware cam 600 is operatively coupled with the operator 602, for instance with a mechanism, such as a rack and pinion. Actuation of the operator 602 moves the seal hardware cam 600 (e.g., rotates the cam) and its associated cam surface 800. The seal hardware cam 600 is configured to transition the floating seal 202 (shown in FIGS. 8A and 8B) between relaxed (shown in FIG. 8B) and compressed configurations (shown in FIG. 8A), for instance by transversely moving the floating sash 102 to correspondingly relax and compress the floating seal 202. In another example, the operation hardware 114 works cooperatively with the seal frame cam 204 (shown in FIG. 4) configured to relax and compress the floating seal 202, for instance with camming bias applied to an associated portion of the floating sash 102A.

In yet another example, the operation hardware 114 includes one or more tilt operators 1000. For example, the tilt operators 1000 are moved to accordingly retract the cam member 606. As shown in FIG. 9, when retracted the cam member 606 is withdrawn into the sash 102 and accordingly retracted from receipt in the fenestration frame 104. With the cam member 606 withdrawn from the fenestration frame 104, tilting movement of the sash 102 (or a panel) is permitted by the movement of the tilt operators 1000.

FIG. 10B is a perspective view of the operation hardware 114 of FIG. 10A in a tilting configuration. For example, the tilt operators 1000 are moved inward in the direction of the dashed arrows shown in FIG. 10B. Compared to FIG. 10A the tilt operators 1000 and the cam members 606 are moved inwardly. Accordingly, the cam member 606 and the seal hardware cam 600 are retracted toward the operator housing 610. With the seal hardware cams 600 retracted from the fenestration frame 104, the associated sash (e.g., 102A, 102B) is permitted to tilt relative to the frame.

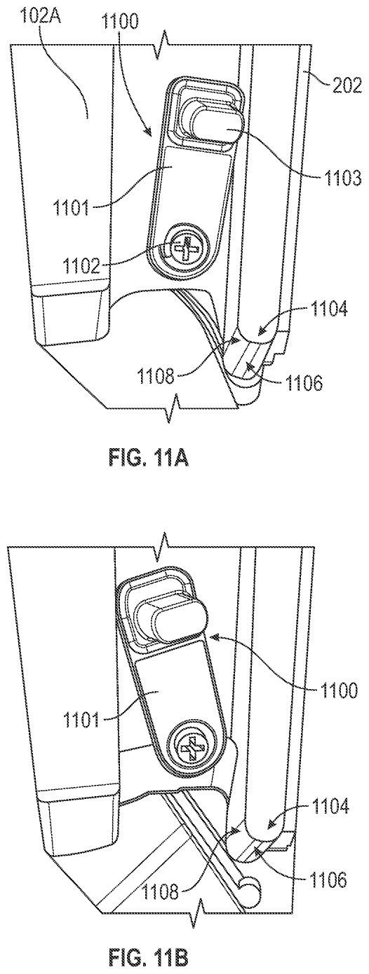

FIGS. 11A, 11B are perspective views of one example of a float linkage 1100 in respective first and second orientations. The first orientation (FIG. 11A) includes the sash 102A in a first lateral position that relaxes the floating seal 202, and the second orientation (FIG. 11B) includes the sash 102A in a second lateral position permitted with the float linkage 1100 that compresses the floating seal 202.

Referring first to FIG. 11A, the float linkage 1100 is moveably coupled with the sash 102A at the sash joint 1102. The float linkage 1100 includes a linkage arm 1101 extending from the sash joint 1102 to a frame joint 1103. The frame joint 1103 is coupled with the fenestration frame 104. The linkage arm 1101 is pivotally coupled between the floating sash 102A and the fenestration frame 104 (shown in FIG. 1) at the sash and frame joints 1102, 1103, respectively.

The linkage arm 1101 is moveable (e.g., about one or both of the sash joint 1102 and the frame joint 1103), and permits lateral translation of the floating sash 102A, for instance between the first and second lateral positions shown in FIGS. 11A, B. Accordingly, the linkage arm 1101 permits translation of the floating sash 102A that correspondingly relaxes and compresses the floating seal 202. For example, and as described herein one or more of the seal frame cam 204 (shown in FIG. 2A) or the operation hardware 114 (e.g., seal hardware cam 600 shown in FIG. 6, or the like) bias the sash 102A laterally. The float linkage 1100 permits lateral movement of the sash 102A initiated with the bias as shown in FIGS. 11A, B that compresses or relaxes the floating seal 202.

FIG. 11B is a perspective view of the float linkage 1100 of FIG. 11A in a second orientation. The float linkage 1100 is moveable to permit lateral translation of the floating sash 102A. For example, the floating sash 102A is moveable between a first lateral position and a second lateral position. FIG. 11B shows the floating sash 102A is in the second lateral position. Accordingly, the linkage arm 1101 in FIG. 11B is shown rotated from the position shown in FIG. 11A. Thus, the floating seal 202 is compressed. For example, (optionally both) of the seal hardware cam 600 of the operation hardware 114 or the seal frame cam 204 (shown in FIG. 2A) bias the floating sash 102A toward the second lateral position and correspondingly compress the floating seal 202.

Referring again to FIG. 11A, the floating sash 102A in this example, includes a wedge drive 1104. As described herein, the wedge drive 1104 provides a cooperative engagement with another feature of the fenestration assembly, such as the deployable jamb stop 500 previously shown in FIGS. 5A, B. For instance, the wedge drive 1104 engages with the jamb stop 500 during tilting of a first sash, such as floating sash 102A, and biases the jamb stop 500 from an intersecting position shown in FIGS. 5A, B to a retracted position misaligned with the sashes 102A, B (shown in FIG. 12B) that frees another sash 102B to also tilt.

The wedge drive 1104 shown in FIGS. 11A, B has a tapered profile proximate to a leading edge of the floating sash 102A (e.g., a bottom rail). The tapered profile extends from, a narrow portion 1106 to a broad portion 1108 with a tapered transition therebetween. In operation, the floating sash 102A is tilted, for instance after retraction of the seal hardware cam 600 to permit tilting. The floating sash 102A tilts, for instance at the sash joint 1102 and the wedge drive 1104 engages with the deployable jamb stop 500 at the narrow portion 1106, as shown in FIG. 12A. The engagement depresses the deployable jamb stop 500. Continued tilting of the floating sash 102A gradually rotates the tapered wedge drive 1104 along the deployable jamb stop 500 and gradually engages the broad portion 1108 to continue driving (e.g., depressing) of the jamb stop 500 to the retracted position shown in FIG. 12B.

FIGS. 12A, B are detailed horizontal cross sections that illustrate the depression of the deployable jamb stop 500 by way of the wedge drive 1104 to a retracted configuration (FIG. 12B). As previously described and shown in FIGS. 5A, B, the jamb stop assembly 502 includes the deployable jamb stop 500 and the biasing element 504. The deployable jamb stop 500 is configured to transition between a deployed configuration (shown in FIG. 12A) and a retracted configuration (shown in FIG. 12B). The bias supplied by the biasing element 504 is, in this example, with the wedge drive 1104 of the floating sash 102A. The wedge drive 1104 engages with the deployable jamb stop 500 and gradually depresses the jamb stop 500 with tilting of the sash 102A. The gradual depression with the tapered profile between narrow and broad portions 1104, 1106 transitions the jamb stop assembly 502 to the retracted configuration shown in FIG. 12B. In another example, a user manually interacts with the jamb stop 500, biasing element 504 or the like (e.g., with the hand, fingers or the like) to overcome the bias and transition the jamb stop 500 to the retracted configuration.

In an example, as shown in FIG. 12A as the first floating sash 102A is tilted (e.g., using the operation hardware 114, for instance retraction of the seal hardware cam 600 or tilting operators 1000 shown in FIG. 10B to permit tilting, or the like). As previously described, tilting of the floating sash 102A engages the narrow portion 1106 of the wedge drive 1104 with the deployable jamb stop 500 to initiate movement of the deployable jamb stop 500 to the retracted configuration. Additional tilting of the floating sash 102A gradually engages the broader portion 1108 of the wedge drive 1104 with the jamb stop 500 as shown in FIG. 12B. The tapered wedge drive 1104 (e.g., the broader portion 1108) continues driving the jamb stop 500 to the retracted configuration. By depressing the jamb stop 500 the stop is no longer aligned with the sash 102B, and the sash 102B is permitted to tilt. Accordingly, the wedge drive 1104 associated with the floating sash 102A permits tilting of the sash 102B. Repositioning of the floating sash 102A in the installed position (e.g., within the frame 104) gradually disengages the wedge 1104 from the deployable jamb stop 500 and permits projection from the configuration shown in FIG. 12B to the deployed position between the sashes 102A, B shown in FIG. 12A. In another example, the opposed side of the floating sash 102A includes another wedge drive 1104 for biasing of another deployable jamb stop 500.

Referring to FIG. 12B, in an example, the fenestration assembly 100 includes a tilt anchor 1200, for instance as a component of the fenestration frame 104. The tilt anchor 1200 is part of a pivot for tilting movement of the sashes 102A, 102B. For instance, upon tilting of the sashes 102A, 102B the tilt anchor 1200 is held static within the fenestration frame 104, for example with deployable cleats. In another example, the tilt anchor 1200 facilitates closing and opening movement (e.g., up and down, or the like). For example, the tilt anchor 1200 is coupled with one or more counterbalances to assist with raising and lowering the sashes 102A, 102B. In another example, the frame joint 1103 (shown in FIG. 11A) is received in the tilt anchor 1200. Accordingly, the float linkage 1100 (shown in FIG. 11A) facilitates coupling of the sash 102A with the fenestration frame 104.

### Various Notes and Aspects

Aspect 1 can include subject matter such as a fenestration assembly comprising: a fenestration frame; at least one floating sash movably coupled within the fenestration frame, the at least one floating sash configured to move between open and closed positions within the fenestration frame, the floating sash includes: a sash perimeter extending around the floating sash; and a sash face; and a floating seal coupled along the sash face, wherein the floating seal includes compressed and relaxed configurations: in the relaxed configuration the floating seal is relaxed and the floating sash is movable between the open and closed positions; and in the compressed configuration the floating seal is compressed relative to the relaxed floating seal in the relaxed configuration.

Aspect 2 can include, or can optionally be combined with the subject matter of Aspect 1, to optionally include wherein the floating seal is coupled between the sash face and the fenestration frame.

Aspect 3 can include, or can optionally be combined with the subject matter of one or any combination of Aspects 1 or 2 to optionally include wherein the floating seal is coupled with the fenestration frame in each of the relaxed and compressed configurations.

Aspect 4 can include, or can optionally be combined with the subject matter of one or any combination of Aspects 1-3 to optionally include wherein in the compressed configuration the compressed floating seal resists movement of the floating sash, and in the relaxed configuration the relaxed floating seal permits movement of the floating sash relative to the compressed floating seal.

Aspect 5 can include, or can optionally be combined with the subject matter of one or any combination of Aspects 1-4 to optionally include wherein the floating sash includes one or more rails and stiles, and the floating seal extends along the sash face associated with the one or more stiles or rails.

Aspect 6 can include, or can optionally be combined with the subject matter of Aspects 1-5 to optionally include wherein the at least one floating sash includes a first floating sash and a second floating sash.

Aspect 7 can include, or can optionally be combined with the subject matter of Aspects 1-6 to optionally include wherein the at least one floating sash is configured to laterally translate relative to movement of the floating sash between the open and closed positions: in the relaxed configuration the at least one floating sash is at a first lateral position; and in the compressed configuration the at least one floating sash is at a second lateral position relative to the first lateral position.

Aspect 8 can include, or can optionally be combined with the subject matter of Aspects 1-7 to optionally include operation hardware coupled with the at least one floating sash, the operation hardware includes: an operator; a seal hardware cam operatively coupled with the operator; and wherein the seal hardware cam is configured to transition the floating sash between the first and second positions lateral and the floating seal between the relaxed and compressed configurations.

Aspect 9 can include, or can optionally be combined with the subject matter of Aspects 1-8 to optionally include a seal frame cam coupled between the fenestration frame and the at least one floating sash, the seal frame cam includes: a cam surface coupled with the fenestration frame; a follower surface coupled with the floating sash; and wherein in the closed position the cam surface is engaged with the follower surface and the seal frame cam is configured to transition the floating sash between the first and second lateral positions and the floating seal between the relaxed and compressed configurations.

Aspect 10 can include, or can optionally be combined with the subject matter of Aspects 1-9 to optionally include a float linkage coupled between the fenestration frame and the at least one floating sash, the float linkage includes: a sash joint coupled with the floating sash; a frame joint coupled with the fenestration frame; a linkage arm coupled with the floating sash at the point joint and the fenestration frame at the frame joint; and wherein rotation of the linkage arm is configured to permit lateral translation of the floating sash between the first and second lateral positions.

Aspect 11 can include, or can optionally be combined with the subject matter of Aspects 1-10 to optionally include wherein in the relaxed configuration the floating seal applies a first friction force to one or more of the fenestration frame or the sash face; and in the compressed configuration the floating seal applies a second friction force to one or more of the fenestration frame or the sash face, and the second friction force is greater than the first friction force.

Aspect 12 can include, or can optionally be combined with the subject matter of Aspects 1-11 to optionally include a jamb stop assembly movably coupled with the fenestration frame, the jamb stop assembly includes: a deployable jamb stop movably coupled with the fenestration frame, the deployable jamb stop including a deployed configuration aligned with the sash face of the at least one floating sash and a retracted configuration misaligned with the sash face; a jamb stop biasing element coupled with the deployable jamb stop, wherein the jamb stop biasing element is configured to bias the deployable jamb top toward deployed configuration.

Aspect 13 can include, or can optionally be combined with the subject matter of Aspects 1-12 to optionally include wherein the floating seal is provided between the sash face and the deployable jamb stop in the deployed configuration.

Aspect 14 can include, or can optionally be combined with the subject matter of Aspects 1-13 to optionally include wherein the at least one floating sash includes a wedge drive having a tapered profile, and tilting of the at least one floating sash is configured to bias the deployable jamb stop toward the retracted configuration.

Aspect 15 can include, or can optionally be combined with the subject matter of Aspects 1-14 to optionally include operation hardware for a floating sash, the operation hardware comprising: a hardware housing; an operator movably coupled with the hardware housing; a latch bolt coupled with the operator, and the latch bolt is configured to transition between deployed and retracted configurations with movement of the operator; a seal hardware cam coupled with the operator, the seal hardware cam includes: a cam surface configured to selectively bias a floating sash between first and second lateral positions; and a cam member coupled between the camming surface and the operator, wherein movement of the operator is transmitted to the cam surface with the cam member.

Aspect 16 can include, or can optionally be combined with the subject matter of Aspects 1-15 to optionally include wherein the cam surface includes a varied profile configured to change between biasing and passive configurations.

Aspect 17 can include, or can optionally be combined with the subject matter of Aspects 1-16 to optionally include wherein the cam surface includes a broad profile in the biasing configuration and a narrow profile in the passive configuration.

Aspect 18 can include, or can optionally be combined with the subject matter of Aspects 1-17 to optionally include wherein in the biasing configuration the cam surface is configured to compress a floating seal between the floating sash and an opposed portion of a fenestration frame; and in the passive configuration the cam surface is configured to relax compression of the floating seal.

Aspect 19 can include, or can optionally be combined with the subject matter of Aspects 1-18 to optionally include wherein the operator includes a lever, and movement of the operator includes rotation of the lever and rotation of the cam member and the cam surface.

Aspect 20 can include, or can optionally be combined with the subject matter of Aspects 1-19 to optionally include wherein the operator and the latch bolt are interconnected with a rack and pinion mechanism.

Aspect 21 can include, or can optionally be combined with the subject matter of Aspects 1-20 to optionally include a keeper configured for installation in one or more of a fenestration frame or a sash, wherein the keeper includes a bolt socket configured to receive the latch bolt in the deployed configuration.

Aspect 22 can include, or can optionally be combined with the subject matter of Aspects 1-21 to optionally include wherein the hardware housing includes a tilt slot, and the operator is movable between retained and tilting configurations: in the tilting configuration the operator is received within the tilt slot and the seal hardware cam is retracted; and in the retained configuration the operator is outside of the tilt slot and the seal hardware cam is deployed relative to the tilting configuration.

Aspect 23 can include, or can optionally be combined with the subject matter of Aspects 1-22 to optionally include wherein the tilt slot extends to the left and right of the operator with the operator in the retained configuration.

Aspect 24 can include, or can optionally be combined with the subject matter of Aspects 1-23 to optionally include wherein the hardware housing includes at least one tilt operator coupled with the seal hardware cam, and the tilt operator is movable between retained and tilting configurations: in the tilting configuration the tilt operator is moved relative to the retained configuration and the seal hardware cam is retracted according to movement of the tilt operator; and in the retained configuration the seal hardware cam is deployed relative to the tilting configuration.

Aspect 25 can include, or can optionally be combined with the subject matter of Aspects 1-24 to optionally include the fenestration frame, and the floating sash movably coupled with the fenestration frame.

Aspect 26 can include, or can optionally be combined with the subject matter of Aspects 1-25 to optionally include a floating seal coupled along a sash face of the floating sash, and the floating seal is in a compressed configuration with the floating sash in the second lateral position; and the floating seal is in a relaxed configuration with the floating sash in the first lateral position.

Aspect 27 can include, or can optionally be combined with the subject matter of Aspects 1-26 to optionally include a method for operating a fenestration assembly comprising: moving at least one floating sash between open and closed positions, moving the at least one floating sash includes: laterally moving the floating sash in a relaxing direction different than a movement direction of the floating sash between open and closed positions; relaxing a floating seal coupled along the floating sash according to the lateral movement in the relaxing direction; and moving the floating sash between the open and closed positions; and securing the at least one floating sash including: laterally moving the floating sash in a compressing direction different than the movement direction of the floating sash between open and closed positions; and compressing the floating seal according to the lateral movement in the compressing direction.

Aspect 28 can include, or can optionally be combined with the subject matter of Aspects 1-27 to optionally include wherein relaxing the floating seal includes decreasing friction force between the floating seal and one or more of the fenestration frame or the sash face for movement between the opened and closed positions; and compressing the floating seal includes increasing friction force between the floating seal and one or more of the fenestration frame or the sash face for movement between the opened and closed positions.

Aspect 29 can include, or can optionally be combined with the subject matter of Aspects 1-28 to optionally include wherein laterally moving the floating sash in one or more of the relaxing or compressing directions includes operating a seal hardware cam of an operation hardware.

Aspect 30 can include, or can optionally be combined with the subject matter of Aspects 1-29 to optionally include wherein the fenestration hardware includes an operator, and laterally moving the floating sash includes manually moving the operator to move the seal hardware cam.

Aspect 31 can include, or can optionally be combined with the subject matter of Aspects 1-30 to optionally include wherein laterally moving the floating sash in the relaxing direction includes disengaging a cam surface from a follower surface of a seal frame cam; and laterally moving the floating sash in the compressing direction includes engaging the cam surface with the follower surface.

Aspect 32 can include, or can optionally be combined with the subject matter of Aspects 1-31 to optionally include wherein laterally moving the floating sash in one or more of the relaxing compressing directions includes articulating a float linkage coupled between the floating sash and the fenestration frame.

Aspect 33 can include, or can optionally be combined with the subject matter of Aspects 1-32 to optionally include wherein moving the floating sash between the open and closed positions includes moving the floating sash within the fenestration frame.

Aspect 34 can include, or can optionally be combined with the subject matter of Aspects 1-33 to optionally include tilting the at least one floating sash relative to the fenestration frame.

Aspect 35 can include, or can optionally be combined with the subject matter of Aspects 1-34 to optionally include wherein the at least one floating sash includes a first floating sash and a second floating sash, and tilting the at least one floating ash includes: engaging a wedge drive of the first floating sash with a deployable jamb stop with tilting of the first floating sash; biasing the deployable jamb stop to a retracted configuration with the wedge drive, the deployable jamb stop in the retracted configuration misaligned with the second floating sash; and tilting the second floating sash.

Each of these non-limiting aspects can stand on its own, or can be combined in various permutations or combinations with one or more of the other aspects.

The above description includes references to the accompanying drawings, which form a part of the detailed description. The drawings show, by way of illustration, specific embodiments in which the invention can be practiced. These embodiments are also referred to herein as “aspects” or “examples.” Such aspects or example can include elements in addition to those shown or described. However, the present inventors also contemplate aspects or examples in which only those elements shown or described are provided. Moreover, the present inventors also contemplate aspects or examples using any combination or permutation of those elements shown or described (or one or more features thereof), either with respect to a particular aspects or examples (or one or more features thereof), or with respect to other Aspects (or one or more features thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Geometric terms, such as “parallel”, “perpendicular”, “round”, or “square”, are not intended to require absolute mathematical precision, unless the context indicates otherwise. Instead, such geometric terms allow for variations due to manufacturing or equivalent functions. For example, if an element is described as “round” or “generally round,” a component that is not precisely circular (e.g., one that is slightly oblong or is a many-sided polygon) is still encompassed by this description.

The above description is intended to be illustrative, and not restrictive. For example, the above-described aspects or examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as aspects, examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

The claimed invention is:

1. A fenestration assembly comprising:
a fenestration frame;
at least one floating sash movably coupled within the fenestration frame, the at least one floating sash configured to move between open and closed positions within the fenestration frame, the floating sash includes:
a sash perimeter extending around the floating sash; and
a sash face; and
a floating seal coupled along the sash face, wherein the floating seal includes compressed and relaxed configurations:
in the relaxed configuration the floating seal is relaxed and the floating sash is movable between the open and closed positions; and
in the compressed configuration the floating seal is compressed relative to the relaxed floating seal in the relaxed configuration.

2. The fenestration assembly of claim 1, wherein the floating seal is coupled between the sash face and the fenestration frame.

3. The fenestration assembly of claim 1, wherein the floating seal is coupled with the fenestration frame in each of the relaxed and compressed configurations.

4. The fenestration assembly of claim 3, wherein in the compressed configuration the compressed floating seal resists movement of the floating sash, and in the relaxed configuration the relaxed floating seal permits movement of the floating sash relative to the compressed floating seal.

5. The fenestration assembly of claim 1, wherein the floating sash includes one or more rails and stiles, and the floating seal extends along the sash face associated with the one or more stiles or rails.

6. The fenestration assembly of claim 1, wherein the at least one floating sash includes a first floating sash and a second floating sash.

7. The fenestration assembly of claim 1, wherein the at least one floating sash is configured to laterally translate relative to movement of the floating sash between the open and closed positions:
in the relaxed configuration the at least one floating sash is at a first lateral position; and
in the compressed configuration the at least one floating sash is at a second lateral position relative to the first lateral position.

8. The fenestration assembly of claim 7 comprising operation hardware coupled with the at least one floating sash, the operation hardware includes:
an operator;
a seal hardware cam operatively coupled with the operator; and
wherein the seal hardware cam is configured to transition the floating sash between the first and second positions lateral and the floating seal between the relaxed and compressed configurations.

9. The fenestration assembly of claim 7 comprising a seal frame cam coupled between the fenestration frame and the at least one floating sash, the seal frame cam includes:
a cam surface coupled with the fenestration frame;
a follower surface coupled with the floating sash; and
wherein in the closed position the cam surface is engaged with the follower surface and the seal frame cam is configured to transition the floating sash between the first and second lateral positions and the floating seal between the relaxed and compressed configurations.

10. The fenestration assembly of claim 7 comprising a float linkage coupled between the fenestration frame and the at least one floating sash, the float linkage includes:
a sash joint coupled with the floating sash;
a frame joint coupled with the fenestration frame;
a linkage arm coupled with the floating sash at the point joint and the fenestration frame at the frame joint; and
wherein rotation of the linkage arm is configured to permit lateral translation of the floating sash between the first and second lateral positions.

11. The fenestration assembly of claim 1, wherein in the relaxed configuration the floating seal applies a first friction force to one or more of the fenestration frame or the sash face; and
in the compressed configuration the floating seal applies a second friction force to one or more of the fenestration frame or the sash face, and the second friction force is greater than the first friction force.

12. The fenestration assembly of claim 1 comprising a jamb stop assembly movably coupled with the fenestration frame, the jamb stop assembly includes:
a deployable jamb stop movably coupled with the fenestration frame, the deployable jamb stop including a deployed configuration aligned with the sash face of the at least one floating sash and a retracted configuration misaligned with the sash face;
a jamb stop biasing element coupled with the deployable jamb stop, wherein the jamb stop biasing element is configured to bias the deployable jamb top toward deployed configuration.

13. The fenestration assembly of claim 12, wherein the floating seal is provided between the sash face and the deployable jamb stop in the deployed configuration.

14. The fenestration assembly of claim 12, wherein the at least one floating sash includes a wedge drive having a tapered profile, and tilting of the at least one floating sash is configured to bias the deployable jamb stop toward the retracted configuration.

15. Operation hardware for a floating sash, the operation hardware comprising:
a hardware housing;
an operator movably coupled with the hardware housing;
a latch bolt coupled with the operator, and the latch bolt is configured to transition between deployed and retracted configurations with movement of the operator;
a seal hardware cam coupled with the operator, the seal hardware cam includes:
a cam surface configured to selectively bias a floating sash between first and second lateral positions; and
a cam member coupled between the camming surface and the operator, wherein movement of the operator is transmitted to the cam surface with the cam member.

16. The operation hardware of claim 15, wherein the cam surface includes a varied profile configured to change between biasing and passive configurations.

17. The operation hardware of claim 16, wherein the cam surface includes a broad profile in the biasing configuration and a narrow profile in the passive configuration.

18. The operation hardware of claim 16, wherein
in the biasing configuration the cam surface is configured to compress a floating seal between the floating sash and an opposed portion of a fenestration frame; and
in the passive configuration the cam surface is configured to relax compression of the floating seal.

19. The operation hardware of claim 15, wherein the operator includes a lever, and movement of the operator includes rotation of the lever and rotation of the cam member and the cam surface.

20. The operation hardware of claim 15, wherein the operator and the latch bolt are interconnected with a rack and pinion mechanism.

21. The operation hardware of claim 15 comprising a keeper configured for installation in one or more of a fenestration frame or a sash, wherein the keeper includes a bolt socket configured to receive the latch bolt in the deployed configuration.

22. The operation hardware of claim 15, wherein the hardware housing includes a tilt slot, and the operator is movable between retained and tilting configurations:
in the tilting configuration the operator is received within the tilt slot and the seal hardware cam is retracted; and
in the retained configuration the operator is outside of the tilt slot and the seal hardware cam is deployed relative to the tilting configuration.

23. The operation hardware of claim 22, wherein the tilt slot extends to the left and right of the operator with the operator in the retained configuration.

24. The operation hardware of claim 15, wherein the hardware housing includes at least one tilt operator coupled with the seal hardware cam, and the tilt operator is movable between retained and tilting configurations:
in the tilting configuration the tilt operator is moved relative to the retained configuration and the seal hardware cam is retracted according to movement of the tilt operator; and
in the retained configuration the seal hardware cam is deployed relative to the tilting configuration.

25. The operation hardware of claim 15 comprising the fenestration frame, and the floating sash movably coupled with the fenestration frame.

26. The operation hardware of claim 25 comprising a floating seal coupled along a sash face of the floating sash, and the floating seal is in a compressed configuration with the floating sash in the second lateral position; and
the floating seal is in a relaxed configuration with the floating sash in the first lateral position.

27. A method for operating a fenestration assembly comprising:
moving at least one floating sash between open and closed positions, moving the at least one floating sash includes:
laterally moving the floating sash in a relaxing direction different than a movement direction of the floating sash between open and closed positions;
relaxing a floating seal coupled along the floating sash according to the lateral movement in the relaxing direction; and
moving the floating sash between the open and closed positions; and
securing the at least one floating sash including:
laterally moving the floating sash in a compressing direction different than the movement direction of the floating sash between open and closed positions; and
compressing the floating seal according to the lateral movement in the compressing direction.

28. The method of claim 27, wherein relaxing the floating seal includes decreasing friction force between the floating seal and one or more of the fenestration frame or the sash face for movement between the opened and closed positions; and
compressing the floating seal includes increasing friction force between the floating seal and one or more of the fenestration frame or the sash face for movement between the opened and closed positions.

29. The method of claim 27, wherein laterally moving the floating sash in one or more of the relaxing or compressing directions includes operating a seal hardware cam of an operation hardware.

30. The method of claim 29, wherein the fenestration hardware includes an operator, and laterally moving the floating sash includes manually moving the operator to move the seal hardware cam.

31. The method of claim 27, wherein laterally moving the floating sash in the relaxing direction includes disengaging a cam surface from a follower surface of a seal frame cam; and
laterally moving the floating sash in the compressing direction includes engaging the cam surface with the follower surface.

32. The method of claim 27, wherein laterally moving the floating sash in one or more of the relaxing compressing directions includes articulating a float linkage coupled between the floating sash and the fenestration frame.

33. The method of claim 27, wherein moving the floating sash between the open and closed positions includes moving the floating sash within the fenestration frame.

34. The method of claim 27 comprising tilting the at least one floating sash relative to the fenestration frame.

35. The method of claim 34, wherein the at least one floating sash includes a first floating sash and a second floating sash, and tilting the at least one floating ash includes:
engaging a wedge drive of the first floating sash with a deployable jamb stop with tilting of the first floating sash;
biasing the deployable jamb stop to a retracted configuration with the wedge drive, the deployable jamb stop in the retracted configuration misaligned with the second floating sash; and
tilting the second floating sash.
